(19) United States
(12) Patent Application Publication
(10) Pub. No.: US 2002/0015384 A1
(43) Pub. Date: Feb. 7, 2002

(54) Broadband Ethernet data flow control

(76) Inventors: Ying Bo Huang, Shanghai (CN); Wei Gao, Shanghai (CN); Xiang Wang, Shanghai (CN); Hanzhong Gao, Germantown, MD (US)

Correspondence Address: BRIAN C. McCORMACK, BAKER & McKENZIE, SUITE 2300, 2001 ROSS AVENUE, DALLAS, TX, 75201, US

(21) Appl. No.: 09/911,079

(22) Filed: Jul. 20, 2001

(30) Foreign Application Priority Data
Jul. 20, 2000 (CN) 00 1 19489.5

(51) Int. Cl. G01R 31/08

(52) U.S. Cl. 370/231; 370/232; 370/235

(57) ABSTRACT

A process is provided for broadband Ethernet data flow control in a computer communication network.

### RELATED APPLICATIONS

This application depends and claims priority from People's Republic of China Application No. 00119489.5 (filed Jul. 20, 2000), which is hereby incorporated by reference herein. Related applications filed concurrently herewith are U.S. Utility Application S/N ______ (filed Jul. 20, 2001) entitled “Broadband Ethernet Video Data Transmission” and U.S. Utility Application S/N ______ (filed Jul. 20, 2001) entitled “Broadband Ethernet Multicasting”, which are hereby incorporated by reference herein.

### BACKGROUND OF THE INVENTION

The present invention relates to a new solution for network data flow control, especially a solution for broadband Ethernet data flow control, and belongs to the computer network communication field.

With bigger bandwidth and larger coverage, the network is developing drastically. Broadband Ethernet is made of 100 mega bits per second (Mbps) fast Ethernet and 1000 Mbps switching Ethernet. Broadband Ethernet has major potentials, as a third level switching technology develops, it can even cover a major city. However, the network environment is complex for broadband Ethernet, as more video data services are added. Also, not only the network has to satisfy the stable data transmission speed and low latency demands of video data transmission, it also has to calculate network data flow as its foundation for service charges. After searching the current technologies available, no solution has been found that can solve the above problems.

### SUMMARY OF THE INVENTION

The present invention overcomes the obstacles in prior art technologies, and provides a solution for network data flow control, which is accurate, effective, simple, and economical.

One aspect of the present invention is a solution for broadband Ethernet data flow control by controlling a network connecting device of at least two connecting ports directly from the network management server, and affect the terminal user, in order to achieve network data flow control of each terminal user and each service.

In another aspect, this invention establishes a protocol between the network management server and the network connecting device, so that the network device can communicate with network management server and report its running condition to the network management server to determine whether a user's service request from one of it's ports can be accepted. The server notifies a service process to the network connecting device after accepting a request. Then the network connecting device can identify which service type the connecting port data belongs to and counts data flow of each service process. Extra data is dropped if one service process data flow exceeds a requested capacity.

### BRIEF DESCRIPTION OF THE FIGURES

FIG. 1 is a sample network constructed with this invention.

FIG. 2 is a flow chart of the process in a network connecting device when a data packet arrives.

### DETAILED DESCRIPTION OF THE INVENTION

According to the invention, in order to enhance certain transmission capability of broadband Ethernet, data flow control and congestion control are necessary. In a nutshell, data flow control works on the data's source and destination end to control data rate; congestion control, however, views the network as a whole and adjusts the data transmission, and usually relies on certain data flow control solution. Therefore, data flow control is an important solution for enhancing network service quality. Broadband Ethernet comprises three major parts: connecting, transmitting, and switching. The connecting part provides a port to a terminal equipment, so that a terminal can connect to a network and share the resource on the network. Equipment that completes this function is called connecting equipment. Such as access server, hub, ethernet switch can be used as connecting equipment. Other equipments which have this function can also be used as connecting equipment. The transmitting part actualizes the transmission of data from one point to another point. Equipment that completes this function is called transmitting equipment. The media by which the transmitting equipment transmit data from each other can be fiber, copper wire, radio, microwave and others. Equipment can act as a transmitting equipment if it can transmit data from one point to another point, whatever media it use for transmitting. The switching part can exchange data from different part of a network. Equipment that completes this function is called switch equipment. Connecting equipments and transmitting equipments can exchange data with other connecting equipments and transmitting equipments by switch equipments. Switch, router can be used as switch equipments. Other equipments which have this function can also be used as switch equipment.

Controlling the connecting equipment directly by the network management server, to affect the terminal user, in order to achieve data flow control to each terminal user and each service, the network management server is at least one equipment that runs programs such as a computer or the like that supervises and manages the network running condition. The connecting equipment first establishes a protocol between the network management server and itself, so that it can report the current network running condition to the server, in order the help the server to judge the users' service requests. After accepting service requests, the server can then notify the authenticating process to the connecting equipment. The connecting equipment will then be able to identify the data's service type and count the data flow of every service process, and drops extra data if the data rate exceeds its allowed capacity. Network management servers in a network can be separated into groups by their position in the network or the service they provide or both. One server can manage part of the network according to it's position, or manage some type of service according to the function and service type it supported, or both.

For each service process of each terminal user, the transmission content could be text, audio, video, numerical or the like. The transmission could be mono or bi-directional. Mono directional transmission could be either sending or receiving data. Transmission can also be point to point, or multicasting. Regardless of the situation, the terminal users can clarify the data's source and destination target and requested data rate as the users request for services.

The network server decides whether or not to accept the service according to the situation of the network condition. If the request is accepted, then the server will notify the connecting equipment the service type and requested data rate. The connecting equipment then supervises the data rate of this service, if the data rate exceeds its allowed capacity which is defined by the network, the extra data will be dropped, in order to achieve data flow control. At the same time, multi-service process can be done to the same user; all service process can be in the same type, or different type. Once the service is finished, the terminal user and network server will cancel this service through relative protocol, and then server will then notify the connecting equipment that the service is over.

This invention is advanced that it can accurately control data flow in every part of the entire network, without worrying network congestion that maybe caused by burst data flow, and simplify network management. During the process of managing service process, it can also easily actualize reasonable accounting function, which provides a solution for Ethernet service charge.

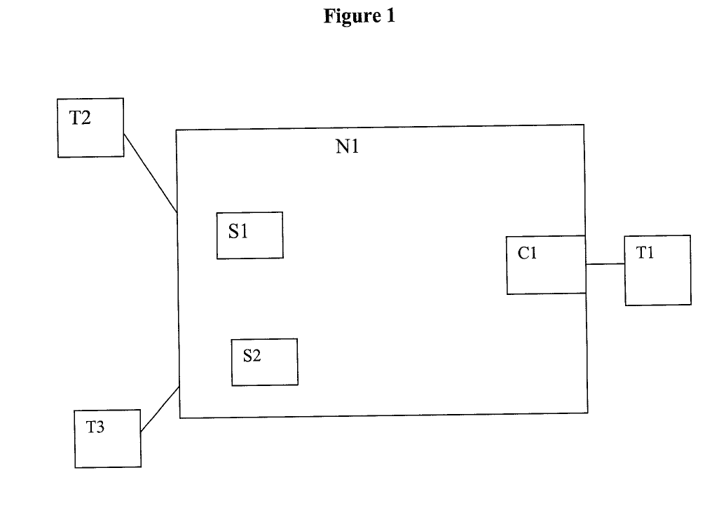

Referring to FIG. 1, T1, T2 and T3 are terminal users, C1 is a connecting equipment, S1, S2 are network management servers, S1 is in charge for managing video service, S2 is in charge for managing data service, N1 is a broadband Ethernet, S1 and 2 are within N1, C1 is on the edge of N1, S1 and 2, and C1 are all a part of N1, T1 connects to broadband Ethernet through C1, the connecting rate for authentication is 2 Mbps.

If T1 needs to service processes, service process A and B, A is a video service between T1 to T2, which needs 1.5 Mbps of transmission rate, B is a data service between T1 to T3, requires transmission rate over 30 kbps, T1 requests process A to S1, S1 accepts the request and notifies C1 with the flag for process A and stable transmission rate of 1.5 Mbps, T1 requests process B to S2, S2 accepts the request and notifies C1 process B's flag and transmission rate over 30 kbps, as C1 finds A's data rate exceeds 1.5 Mbps, extra data will be dropped, as C1 finds B's data rate exceeds 30 kbps, however, since there are only two service process currently, it is allowed for B to occupy all data flow other than allowed flow for A, so, B can occupy data flow between 30 kbps to 500 kbps.

In the above process, C1 has certain specific functions added to support this invention. First, C1 has a program to process network protocol, through this program, C1 communicates with S1 and S2 and notifies its condition to them, and receives information from S1 and S2. Second, C1 can observe all the data go through it and distinguish the data from different service of differ terminal users. Third, there are some counters built in C1, C1 record the running condition of each service of each user in these counters. Fourth, C1 can calculate the data rate of each service of each user by the information in the counters and information from network management servers, and judge if data rate of any service of any user exceeds the limit it allowed, and drop the extra data. It must be mentioned that this invention does not specify the precision and the range of data rate. In theory, the data rate dispatch to a service process can be user defined.

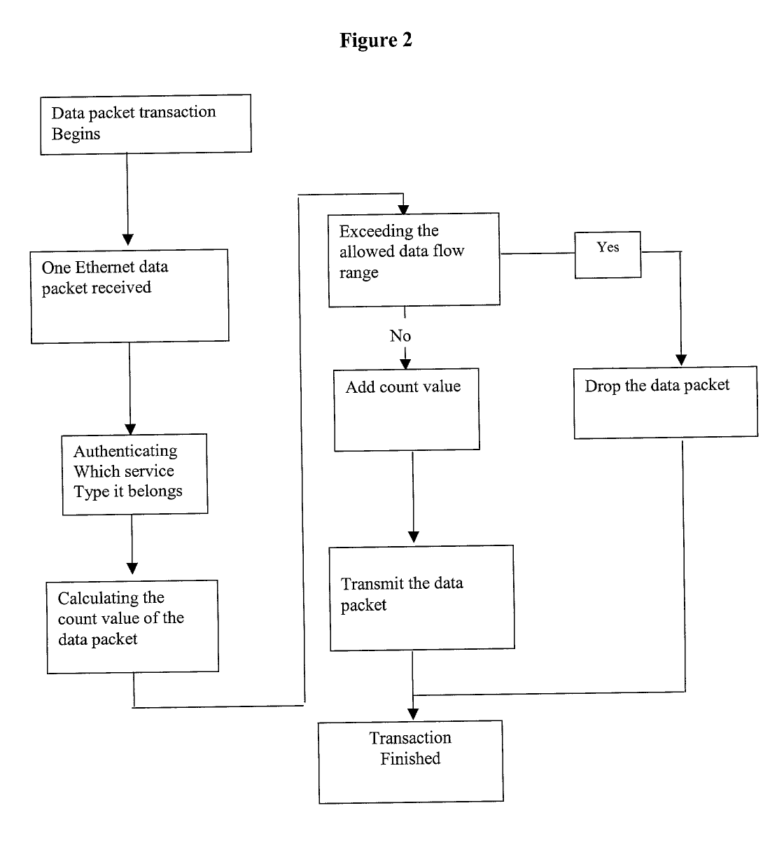

Referring to FIG. 2, when C1's connecting equipment receives an Ethernet data packet, it identifies the service type of the packet through the flag, takes out reflective count value, confirms the packet length, and then judge count value of the packet; if the value exceeds the allowed capacity, the packet will be dropped, otherwise, count value will be added and then the packet will be sent. After a certain time, C1 will zero calculator and restart calculating.

Thus, this data flow control solution divides the data flow control to each user's each service.

It is to be understood that while the invention has been described in conjunction with the above embodiments, that the foregoing description and the following figures are intended to illustrate and not limit the scope of the invention. Other aspects, advantages and modifications within the scope of the invention will be apparent to those skilled in the art to which the invention pertains.

What is claimed is:

1. A process for network data flow control comprising:
controlling a network connecting device of at least two connecting ports directly from a network management server in order to achieve data flow control of each terminal user and each service.

2. The process of claim 1, further comprising the steps of:
(a) establishing a protocol between a network management server and a network connecting device of at least two connecting ports;
(b) reporting the network connecting device's running condition to the network management server by the protocol in (a);
(c) determining by the network management server whether a user's service request can be accepted;
(d) notifying a service process to the connecting port;
(e) identifying service type;
(f) counting data flow of each service process; and
(g) dropping extra data if one service process data flow exceeds a requested capacity.

3. The process of claim 2 wherein more than one network management server can manage a network corporately these network management servers are separated into groups by their position in the network or the service they provide or both.

4. The process of claim 3 wherein the net connecting device receives an Ethernet data packet and will identify the flag to see which service process the packet belongs, check the related counters, confirm the length of the packet, and then judge if the data rate exceeds its limit, if it does, it will be dropped, otherwise re-calculate the counters and forward the packet.

5. The process of claim 4 wherein the network management server is a computer.

6. The process of claim 5 further comprising a terminal user which is a device that can send and receive Ethernet data packets.

7. The process of claim 6 wherein the service is selected from the group consisting of a video service, audio service, text service, unicast service and multicast service.

8. The process of claim 4 wherein the data rate of each service is user defined.
